(19) United States
(12) Patent Application Publication
(10) Pub. No.: US 2015/0112804 A1
(43) Pub. Date: Apr. 23, 2015

(54) METHOD FOR PRESENTING SALES INFORMATION AND SYSTEM FOR PRESENTING THE SAME

(71) Applicant: TOSHIBA TEC KABUSHIKI KAISHA, Tokyo (JP)

(72) Inventor: Akihiko FUJIWARA, Yokohama Kanagawa (JP)

(21) Appl. No.: 14/521,067

(22) Filed: Oct. 22, 2014

(30) Foreign Application Priority Data
Oct. 23, 2013 (JP) 2013-220468

(51) Int. Cl. G06Q 30/02

(52) U.S. Cl. CPC G06Q 30/0255; G06Q 30/0267
USPC 705/14.53

(57) ABSTRACT

A method for presenting sales information on a display device to a user who is shopping at a first store includes executing a first operation on a processor coupled to the display device to determine an item to promote to a user, executing a second operation on the processor to acquire first price information about a price of the item that is on sale at the first store, executing a third operation on the processor to acquire second price information about a price of the item that is on sale at a second store, generating a discount information for the item that is on sale at the first store based on the first price information and the second price information, and controlling the display device to display the generated discount information.

### CROSS-REFERENCE TO RELATED APPLICATION

This application is based upon and claims the benefit of priority from Japanese Patent Application No. 2013-220468, filed Oct. 23, 2013, the entire contents of which are incorporated herein by reference.

### FIELD

Embodiments described herein relate generally to a technique for presenting merchandise sales information.

### BACKGROUND

Presenting sales information, such as discount information, in a store is useful for a customer who wants to purchase a product at the store. However, it is hard for the store to recognize specific attributes of the customer, such as purchase history at the store, so as to encourage the customer to purchase the product from the store.

Recently, customers tend to check the prices of the same product at other stores using a mobile device while they are in the store. When the price at one of the other stores is lower than the price at the store where the customer is in, the customer may refrain from purchasing the product from the store.

### DESCRIPTION OF THE DRAWINGS

FIG. 1 illustrates an example of a sales information presentation system according to an embodiment.

FIG. 2 illustrates an example of control blocks of the sales information presentation system according to the embodiment.

FIG. 3 is a flowchart of processes carried out by a sales information presentation system.

FIG. 4 illustrates an initial screen displayed on a display of a signage MFP.

FIG. 5 is an example of a data table showing a user's purchase history.

FIG. 6 illustrates an example of a data table showing a user's past purchase history.

FIG. 7 illustrates an example of a data table showing various pieces of information used to generate a coupon.

FIG. 8 illustrates available discount coupons displayed on the display of the signage MFP.

FIGS. 9-11 illustrate an operation to select a discount coupon from the coupons displayed on the display of the signage MFP.

### DETAILED DESCRIPTION

Embodiments provide a technique that presents information on merchandise for sale at a store to motivate a customer who is considering a merchandise for purchase to purchase the merchandise at the same store.

In general, according to one embodiment, a method for presenting sales information on a display device to a user who is shopping at a first store includes executing a first operation on a processor coupled to the display device to determine an item to promote to a user, executing a second operation on the processor to acquire first price information about a price of the item that is on sale at the first store, executing a third operation on the processor to acquire second price information about a price of the item that is on sale at a second store, generating a discount information for the item that is on sale at the first store based on the first price information and the second price information, and controlling the display device to display the generated discount information.

Hereinafter, an embodiment will be described with reference to the accompanying drawings.

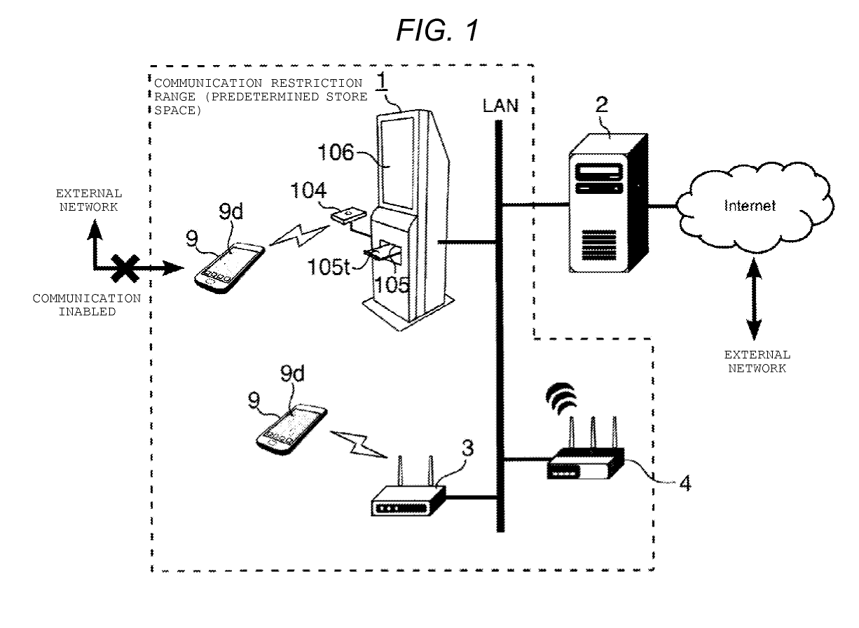

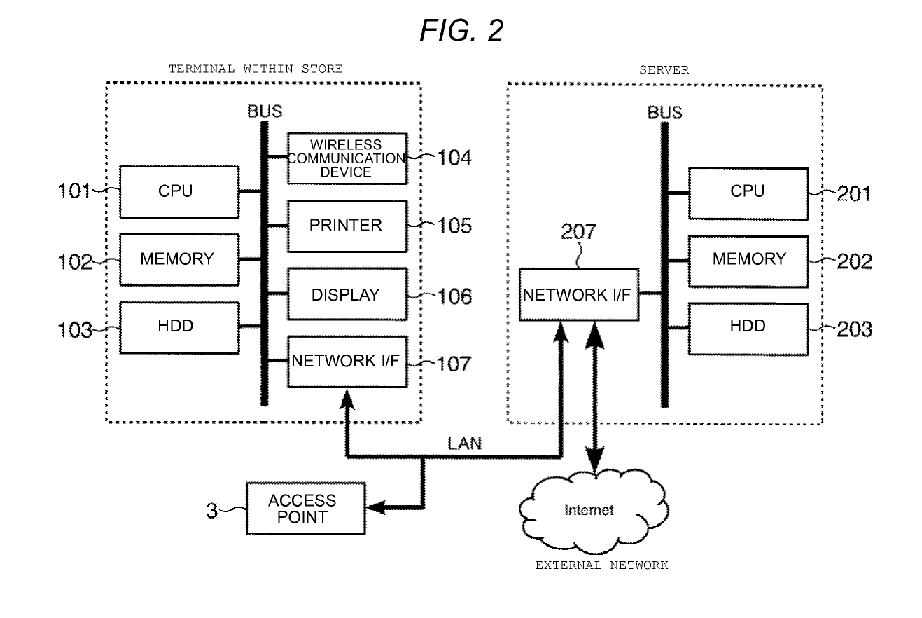

FIG. 1 illustrates an example of a configuration of a sales information presentation system according to an embodiment. FIG. 2 is an example of control blocks of devices configuring the sales information presentation system according to the embodiment.

As illustrated in FIG. 1, the sales information presentation system according to the embodiment may include, for example, a signage multifunction peripheral (MFP) 1 as a multifunctional terminal device, a server 2, an access point 3, a jamming device 4, and the like.

The signage MFP 1, the server 2, the access point 3, and the jamming device 4, which configure the sales information presentation system according to the embodiment, are connected to each other so as to be capable of communicating with each other through an electric communication line such as, for example, a LAN. Here, a communication among the devices of the signage MFP 1, the server 2, the access point 3, the jamming device 4 is not limited to wired communication, and wireless communication such as a wireless LAN may be used.

Subsequently, each of the components, such as the signage MFP 1 to the jamming device 4, which configure the sales information presentation system, will be described in detail.

The signage MFP 1 and the access point 3 are installed, for example, within a store (predetermined store space) where communication is restricted due to the jamming device 4. In this embodiment, a case where the server 2 is disposed outside the predetermined store space is described, but the embodiment is not necessarily limited thereto. The server may be disposed within the predetermined store space together with the signage MFP 1 and the like. In other words, as long as the server 2 can communicate with the signage MFP 1 and the access point 3, the arrangement thereof is not limited.

Here, the “predetermined store space” will be described by using as an example an area where communication with the outside is restricted due to a technique such as so-called jamming, but the embodiment is not limited thereto. An area and the like where communication with the outside is restricted due to reasons such as the structure, material, and the like of a building may also be included in the “predetermined store space”. It is hard to have an access to external websites, such as a price comparison site, an online shopping site, and the like by using a portable terminal such as a smart phone, within the “predetermined store space.”

In addition, the term “store space” used herein is not limited to a closed space such as a room. The store space may include a sales space provided outdoors which is not equipped with communication infrastructure, a sales space where communication is restricted due to a shield such as a building, and the like, and a space where sales is performed has no limitation.

The signage MFP 1 may include, for example, a CPU 101, a memory 102, a hard disk drive (HDD) 103, a wireless communication device 104, a printer 105, a display 106, and a network I/F 107. Various devices included in the signage MFP 1 are connected to each other so as to be capable of communicating with each other through a bus.

The CPU 101 has a role in performing various processes in the signage MFP 1, and also has a role in achieving various functions by executing programs stored in the memory 102, the HDD 103, and the like. Meanwhile, it is needless to say that the CPU 101 may also be replaced with a microprocessing unit (MPU) capable of executing the same computation process.

The memory 102 maybe, for example, a random access memory (RAM), a read only memory (ROM), a dynamic random access memory (DRAM), a static random access memory (SRAM), a video RAM (VRAM), a flash memory, or the like. The memory 102 and the HDD 103 have roles in storing various pieces of information and programs which are used in the sales information presentation system.

The wireless communication device 104 has a function of communicating with a customer's portable terminal such as a mobile phone and performing an authentication process. For example, the device may perform processes of acquiring ID information from the portable terminal and transmitting an electronic coupon to the portable terminal. Communication between the wireless communication device 104 and the portable terminal may be carried out using various communication standards such as, for example, infrared communication, wireless fidelity (Wi-Fi), Bluetooth, and ToruCa (registered trademark). Here, a case where the communication between the wireless communication device 104 and the portable terminal is performed in accordance with ToruCa will be described as an example.

The printer 105 ejects a sheet on which search results, results of various processes, and the like are printed, onto a tray 105t of the signage MFP 1. It is also possible to print out various coupons presented by the signage MFP 1 together with a QR code and the like.

The display 106 is, for example, a touch panel display, and includes an image display device, such as an electronic paper, a liquid crystal display (LCD), an electronic luminescence (EL), a plasma display panel (PDP), a cathode ray tube (CRT), or the like, and an operation input unit which is provided on the image display device and receives a user's operation input.

The network I/F 107 has a role as an interface for the signage MFP 1 to communicate with the server 2 and the access point 3 through a network such as a LAN.

The server 2 may include, for example, a CPU 201, a memory 202, an HDD 203, and a network I/F 207. Various devices included in the server 2 are connected to each other so as to be capable of communicating with each other through a bus.

The CPU 201 has a role in performing various processes in the server 2, and also has a role in achieving various functions by executing programs stored in the memory 202, the HDD 203, and the like. Meanwhile, the CPU 201 may be replaced with an MPU capable of executing the same computation process.

The memory 202 may be, for example, a random access memory (RAM), a read only memory (ROM) , a dynamic random access memory (DRAM), a static random access memory (SRAM), a video RAM (VRAM), a flash memory, or the like. The memory 202 and the HDD 203 have roles in storing various pieces of information and programs used in the sales information presentation system.

For example, the network I/F 207 has a role as an interface for the server 2 to communicate with the outside through a network such as a LAN or the Internet.

The access point 3 is, for example, a wireless LAN access point, and has a role in connecting a wireless LAN client (wireless terminal) such as a mobile phone or a smart phone to the signage MFP 1 and the server 2 or to another network (wired LAN or the like). The server 2 may provide a web page and the like stored in the HDD 203 to a portable terminal having access to the server 2 through the access point 3 or may selectively permit the access to an external network such as the Internet. Thus, the portable terminal having access to the server 2 from the access point 3 may attributively have access to only a specific web page which is determined in advance through the access point 3 and the server 2.

The jamming device 4 has a function of causing the portable terminal to be incapable of receiving a signal due to radio noise or the like. The portable terminal cannot have access to an external network within the reach of radio noise generated by the jamming device 4. Accordingly, the “predetermined store space” used herein may also be regarded as a range in which the radio noise generated by the jamming device 4 reaches with sufficient radio field intensity for jamming.

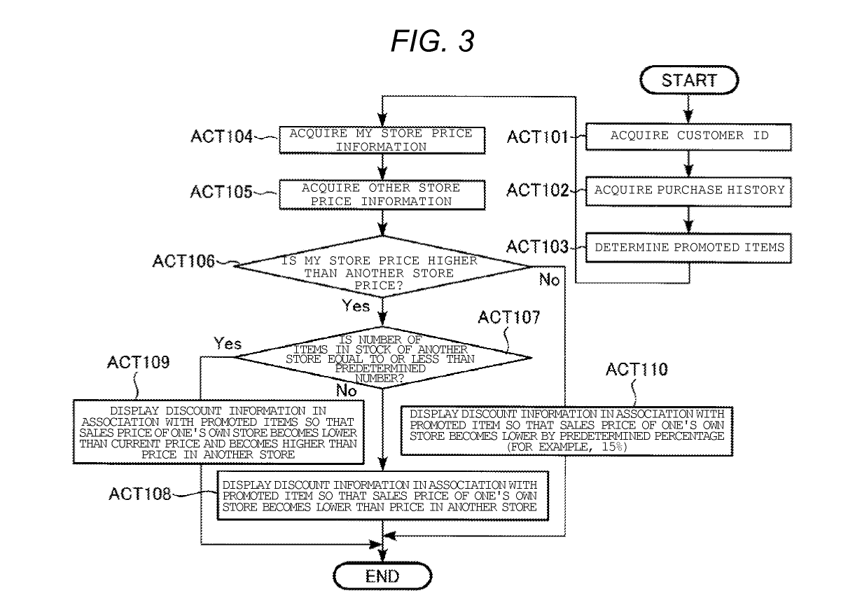

FIG. 3 is a flow chart illustrating a flow of processes carried out in the sales information presentation system.

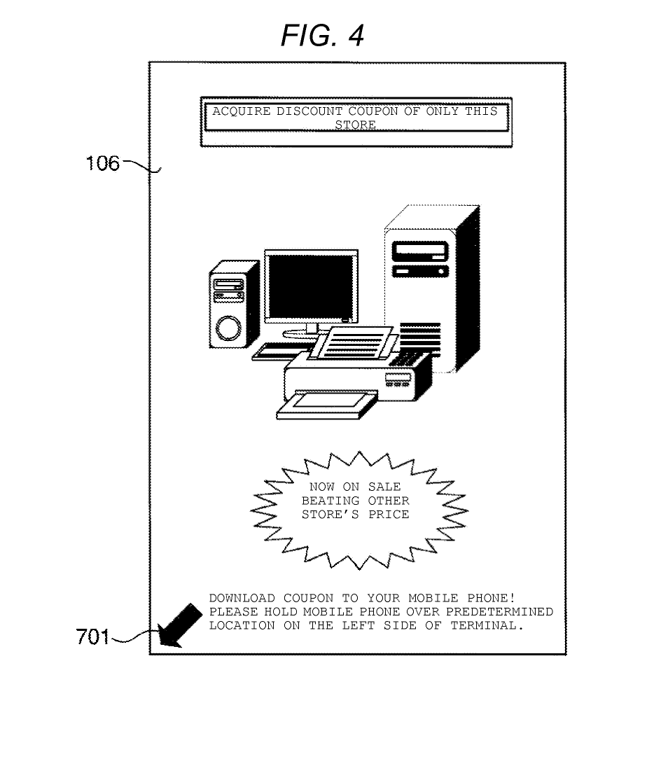

The CPU 101 of the signage MFP 1 controls the display 106 to display an initial screen illustrated in FIG. 4 in a standby state. An arrow icon 701 illustrated on the lower left side of the screen of the display 106 indicates a direction to the wireless communication device 104.

When a user holds his or her own portable terminal over the wireless communication device 104 of the signage MFP 1, the CPU 101 performs user authentication (ACT101). Various pieces of information necessary for the user authentication may be stored in, for example, at least one of the memory 202 and the HDD 203 of the server 2. Meanwhile, the user authentication process through the wireless communication device 104 is not necessarily limited to authentication using a portable terminal, and the user authentication may be performed by reading a membership card or various ID cards using various card readers which are ordinarily included in the wireless communication device 104 and the signage MFP 1.

The CPU 101 acquires information indicating a purchase history associated with user's identification information which is authenticated through the wireless communication device 104, from at least one of the memory 202 and the HDD 203 of the server 2 (ACT102).

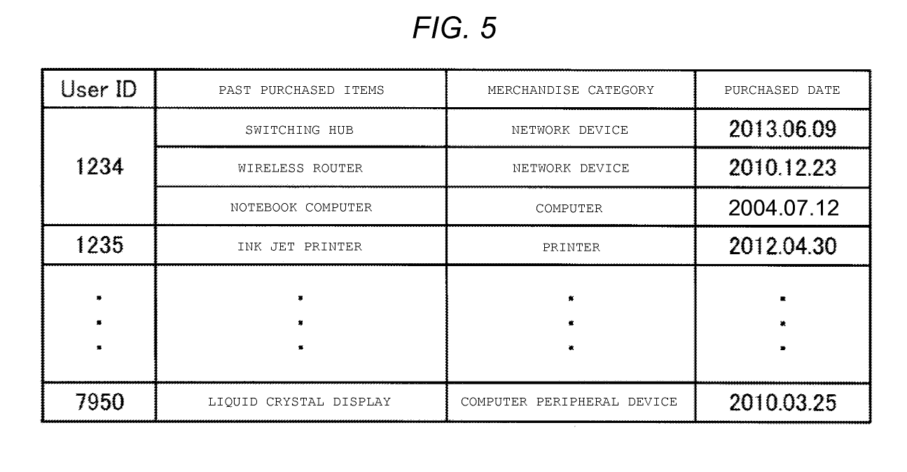

FIG. 5 is an example of a data table showing a user's purchase history. The data table illustrated in FIG. 5 may be stored in, for example, at least one of the memory 202 and the HDD 203 of the server 2.

The CPU 101 sets (1) an item having a name, a merchandise category, and an usage environment at least one of which is the same as or similar to those of a past purchased item indicated by the purchase history and (2) an item typically used in association with the past purchased item indicated by the purchase history, as “promoted items” of which discount information is to be displayed by a display terminal (ACT103).

The term “merchandise category” used herein includes categories indicating merchandise attributes such as, for example, “network devices”, “computers”, “printers”, “computer peripheral devices”, “stationery”, “sports goods”, and “leather goods”. In addition, the items having the same or similar “usage environment” include items used in sets or often used in the same situation such as, for example, a “ski plate” in association with “ski boots” or a “printer” in association with “ink for a printer”.

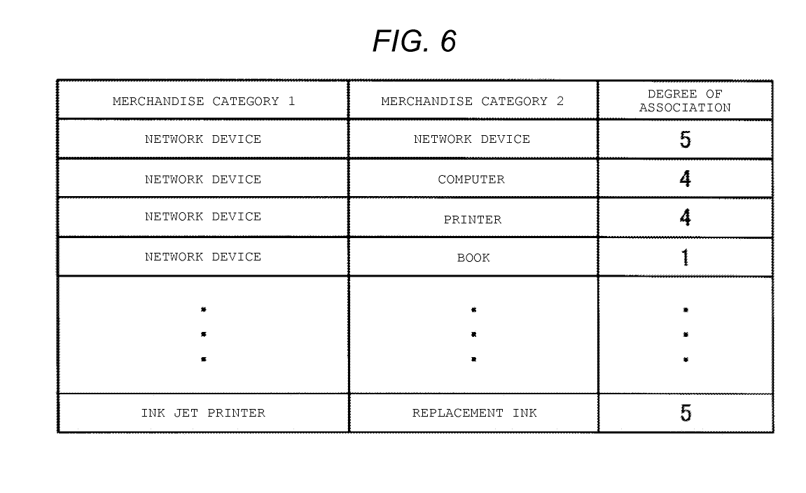

Meanwhile, in this embodiment, the CPU 101 determines (1) which one of user's past purchased items has a name, a merchandise category, and a usage environment of which at least one is similar to those of the past purchased item indicated by the purchase history or (2) which one of user's past purchased items has a relationship such as being used in association with the past purchased item indicated by the purchase history, based on the data table, illustrated in FIG. 6, which is stored in, for example, at least one of the memory 202 and the HDD 203 of the server 2.

Here, for example, the CPU 101 determines that an item having an association degree of “4” or higher meets at least one of (1) and (2) described above. Accordingly, for example, when the purchase history information illustrated in FIG. 5 includes a purchase history of a user having an ID of “1234”, a “network device”, a “computer”, and a “printer”, which have a high association degree with respect to the “network devices” which is a merchandise category of a “switching hub” and a “wireless router,” which were purchased in the past by the user having an ID of “1234”, are selected as “promoted items” when the user is authenticated. As illustrated in FIG. 5, when a past purchased item, a notebook computer, was purchased more than 10 years ago, which is longer than a predetermined average durable years (for example, 7 years), new purchase of the notebook computer is expected and a process of adding the notebook computer to the promoted items which are targets of a coupon display may be performed.

As described above, when the “promoted item,” which is a target of a coupon display, is determined, the CPU 101 acquires “my store price information” indicating the current sales price of the promoted item within the predetermined store space (ACT104).

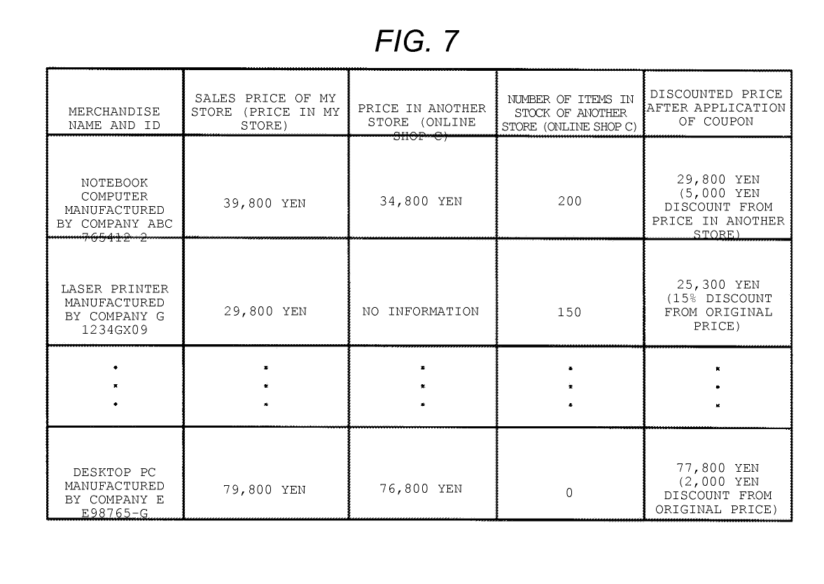

For example, at least one of a “merchandise name” and “merchandise identification information (ID)” is stored in at least one of the memory 202 and the HDD 203 of the server 2 in association with the “my store price information” (see FIG. 7). The CPU 101 acquires “my store price information” stored in this manner, based on, for example, at least one of the “merchandise name” and the “merchandise identification information (ID)” of the “promoted item”.

Subsequently, the CPU 101 acquires “other store price information” indicating a sales price in other stores outside the predetermined store space, with respect to an item having the same merchandise identification information as that of the “promoted item” (ACT105).

The term “merchandise identification information” used herein includes, for example, a model number of an item, a merchandise name, and the like. In addition, “other store” used herein is not limited to a real store actually having a building or a physical sales space and includes an online shop operated on the Internet, and the like. In this manner, when “other store price information” is acquired via a network, a URL of a web site serving as an acquisition destination, or the like, login information, and the like may be registered in advance in the memory 202 and the HDD 203 of the server 2.

Here, as “other store price information”, it is possible to acquire a price offered in association with the item in a case of an online shop, or to acquire a lowest price displayed in a web site in which the comparison between sales prices of a certain item in a plurality of stores is displayed.

Further, the terms “my store price information” and “other store price information” used herein are not necessarily merchandise prices (numerical values) , and may be any other information (for example, a rank or the like) which suggests a merchandise price, or the like.

Next, the CPU 101 determines whether or not a sales price indicated by “my store price information” acquired in the above-described manner is higher than a sales price indicated by “other store price information” (ACT106).

The CPU 101 acquires information indicating the number of items in stock, which have the same merchandise identification information as that of the promoted item, in another store selling the item at a lower price, and determines whether the number of items in stock obtained from the inventory information indicating the number of items in stock is equal to or less than a predetermined number (ACT107). For example, when the predetermined number herein is “50”, the numbers of items in stock of both a “notebook computer manufactured by a company ABC” and a “laser printer manufactured by a company G”, which are illustrated in FIG. 7, are not equal to or less than the predetermined number.

When the sales price indicated by “my store price information” is higher than the sales price indicated by “other store price information” (ACT106, Yes) and when the number of items in stock obtained from the inventory information is larger than the predetermined number or the inventory information indicates that there is a large number of items in stock (ACT107, No) , the CPU 101 causes discount information, indicating that a real price of a promoted item within a predetermined store space becomes lower than the sales price indicated by “my store price information”, to be displayed on the display 106 in association with the promoted item (ACT108).

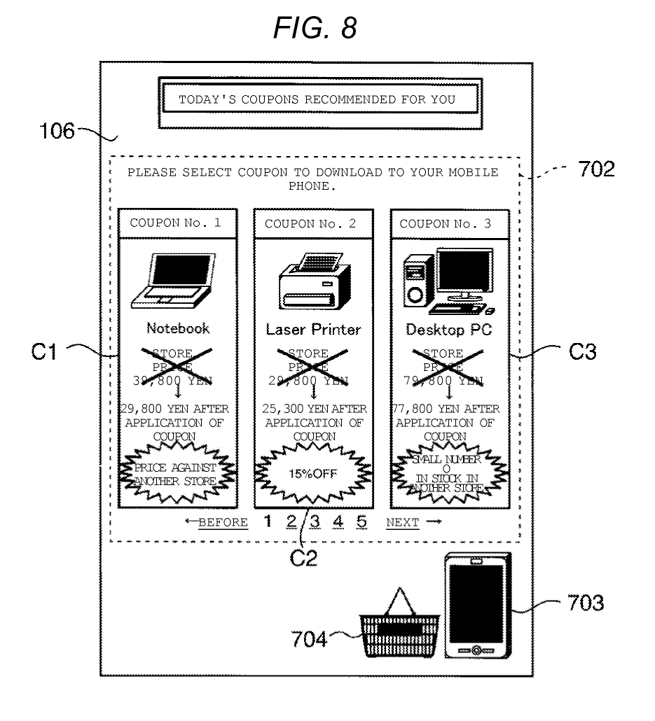

For example, a discount coupon with respect to the “notebook computer manufactured by a company ABC” illustrated in FIG. 7 is displayed, an original sales price of one's own store is 39,800 yen, and a sales price in an online shop C of another store is 34,800 yen. Thus, the price in one's own store is higher than the sales price in the online shop C. In addition, the number of items in stock with respect to the “notebook computer manufactured by a company ABC” in the online shop C is 200, which is sufficient, and thus it may be determined that the online shop C has customer attraction, from the above-described information. Consequently, the CPU 101 causes a coupon C1 in which 29,800 yen, which is a price obtained by discounting 5,000 yen from 34,800 yen as the sales price of another store, is set to be a discounted sales price of the “notebook computer manufactured by a company ABC” in one' s own store, to be displayed in a coupon display region 702 on the display 106 (see FIG. 8).

The term “real price” used herein means a final price (expenditure) after a privilege such as the benefits of a coupon, reward points, or a cashback is applied thereto (a substantial discount is applied thereto). The application of a coupon, the reward points, the cashback, and the like used herein are not limited to the ones available only at the time of purchasing the item immediately, and the ones available when the customer visits the store next time are included (for example, a discount coupon available when the customer visits the store next time).

Meanwhile, the “display terminal used within a predetermined store space” may be a display terminal used within a store space by a user, and includes, for example, a multimedia kiosk and a display terminal for information browsing, which are installed within a predetermined store space, a mobile phone, a PDA, a tablet terminal, and the like which belong to a user.

When “the number of items in stock indicated by the inventory information is equal to or less than a predetermined number” or when “the inventory information indicates that the number of items in stock is small” (ACT107, Yes) , the CPU 101 causes discount information to be displayed on the display 106 in association with the to-be-sold merchandise, so that a discounted price of a promoted item within a predetermined store space is lower than the sales price indicated by “my store price information” and is higher than the sales price indicated by “other store price information.” (ACT109).

For example, when a discount coupon with respect to a “desktop PC manufactured by a company E” illustrated in FIG. 7 is displayed, an original sales price of one's own store is 79,800 yen (see FIG. 7), and a sales price in the online shop C is 76,800 yen. Thus, the price of one's own store is higher than the sales price in the online shop C. However, the number of items in stock with respect to a “desktop PC manufactured by a company E” in the online shop C is zero. Accordingly, even if a customer is attracted to the sales price of the online shop C, the customer cannot immediately purchase the “desktop PC manufactured by a company E” from the online shop C, and thus it may be said that one's own store is in an advantageous situation. Consequently, the CPU 101 causes 77,800 yen, which is a price obtained by discounting 2,000 yen from 79,800 yen as the original sales price of one's own store and which is a higher than the sales price of another store, to be displayed as a coupon C3 serving as the discounted sales price of the “desktop PC manufactured by a company E” in one's own store, in the coupon display region 702 on the display 106 (see FIG. 8).

In addition, when the sales price indicated by “my store price information” is not higher than the sales price indicated by “other store price information” (ACT106, No), the CPU 101 is not required to perform a large discount because an attractive price has been already set with respect to another store. Consequently, the CPU 101 lowers the sales price of the promoted item (for example, the laser printer manufactured by a company G) in one's own store by a predetermined percentage (for example, 15%) and causes the discount information to be displayed as a coupon C2 in correlation with the promoted item in the coupon display region 702 of the display 106 (see FIG. 8).

Meanwhile, on a screen illustrated in FIG. 8, an icon 703 of a mobile phone on the lower right side indicates a state where the connection between the wireless communication device 104 and the mobile phone is being currently made.

“Case where the number of merchandises in stock is equal to or less than a predetermined number” means, for example, a case where the number of merchandises in stock is equal to or less than nine (including zero) when the predetermined number is ten. “Case where inventory information indicates that the number of the items in stock is small” means, for example, a case where the inventory information indicates that the inventory is about to run out such as “few items in stock”, “a small number of items in stock”, or “just a few left”.

“Discount information” is at least any one of (1) a real sales price of a promoted item at the time of purchasing the item within a predetermined store space, (2) coupon information capable of making a real purchase price of a promoted item within a predetermined store space lower than the sales price indicated by “my store price information” by the use thereof within the predetermined store space, and (3) information indicating a cashback amount, which is capable of making a payment amount with respect to a promoted item within a predetermined store space substantially lower than the sales price indicated by “my store price information.”

Meanwhile, “information indicating a cashback amount” means, for example, reward points and the like.

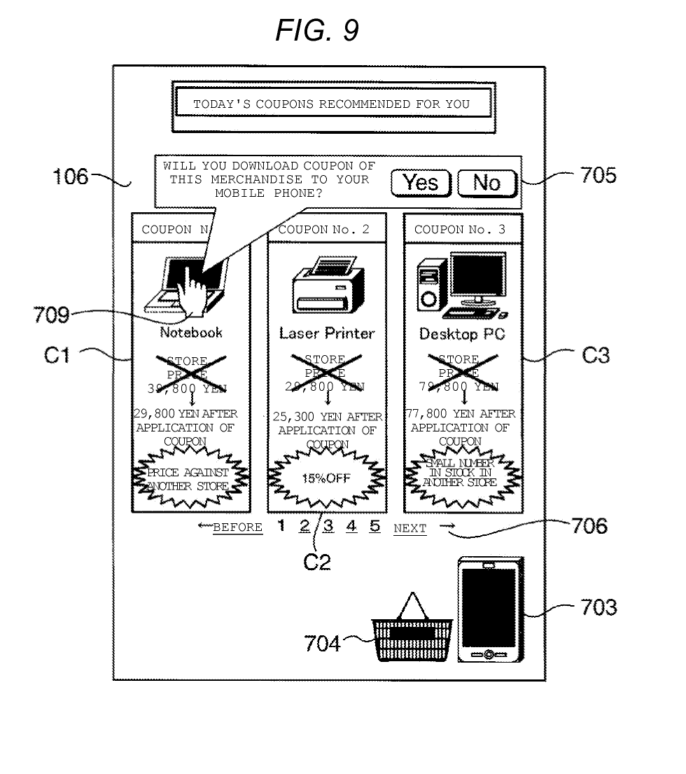

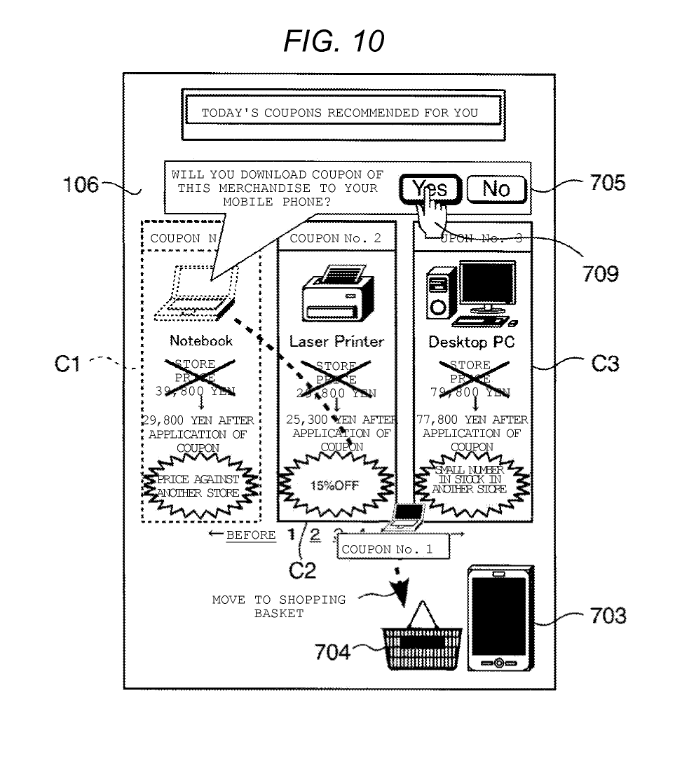

When a user selects a coupon (for example, the coupon C1 of the notebook computer) on the screen illustrated in FIG. 8, the CPU 101 causes a balloon 705, illustrated in FIG. 9, to be displayed on the display 106. When the user selects “Yes” in the balloon 705, the CPU 101 displays an animation in which an image corresponding to the coupon C is moved toward a shopping basket icon 704 (see FIG. 10).

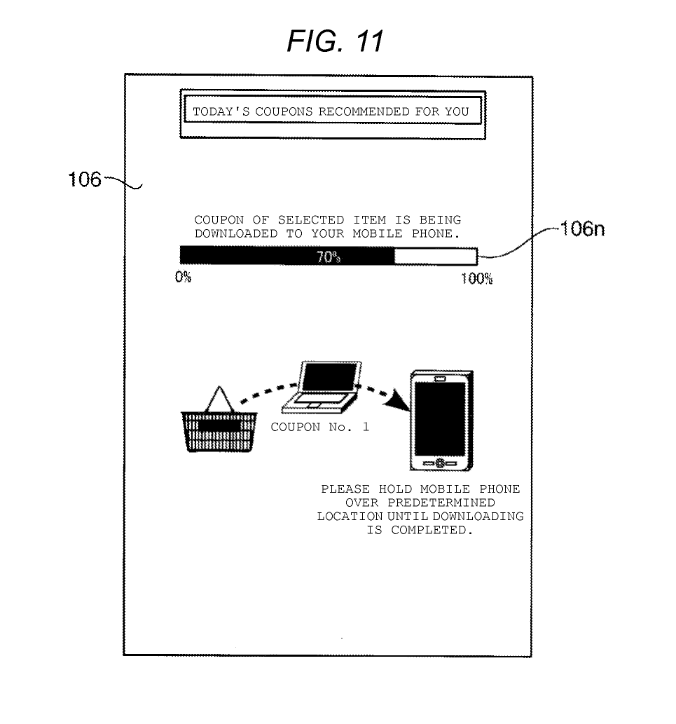

When the downloading of the desired coupon to a mobile phone is started, the progress of the downloading of the coupon C to the mobile phone is shown by an indicator display such as a progress bar illustrated in FIG. 11. In this manner, the user may acquire the desired coupon within a store where communication is restricted and may use the coupon as a discount coupon at the time of payment, similar to an ordinary electronic coupon.

In the above-described embodiment, a coupon is displayed on the display 106 of the signage MFP 1, but the embodiment is not limited thereto. For example, it is also possible to display a user interface and coupon information illustrated in FIGS. 8 to 11 on a screen of a display 9d of a portable communication terminal 9 such as a mobile phone by providing a web page or the like from the server 2 through the access point 3.

In the above-described embodiment, most processing functions configuring the sales information presentation system are achieved by the CPU 101 of the signage MFP 1. However, various functions configuring the sales information presentation system are not necessarily required to be included in only the signage MFP 1, and necessary processing functions in the entire sales information presentation system may be achieved. For example, it is also possible to adopt a so-called thin client system or the like in which the signage MFP 1 is used as a client and the server 2 is used as a thin client server, as the occasion demands as necessary.

In the above-described embodiment, most pieces of information (one's own store price information, another store price information, the degree of association between merchandises, and the like) which are used for various determination processes and various computation processes in the sales information presentation system are stored in at least one of the memory 202 and the HDD 203 of the server 2. However, the embodiment is not limited thereto, and a portion or the entirety of these necessary pieces of data maybe located dispersedly and stored in a plurality of storage regions. In addition to a procedure in which the acquisition of another store price information is started at a timing when user's identification information is acquired, a configuration may be adopted in which, for example, merchandises being currently sold in a shop front are monitored at all times and are automatically downloaded. Thus, it is possible to reduce a computation load of a CPU at the time of displaying a coupon.

The operations in the above-described sales information presentation system may be achieved by executing sales information presentation programs stored in the memory 102, the HDD 103, the memory 202, the HDD 203, and the like by the CPU 101 and the CPU 201.

Further, a program that causes a computer configuring a sales information presentation system to execute the above-described operations may be provided as a sales information presentation program. In this embodiment, the program for performing the functions to carry out the exemplary embodiment is recorded in advance in the storage area provided within an apparatus. However, the embodiment is not limited thereto, and a similar program may be downloaded to the apparatus from a network or a similar program stored in the computer-readable recording medium may be installed in the apparatus. The recording medium may be any form as long as the recording medium may store the program and may be read by a computer. Specifically, the recording medium may be, for example, an internal storage device that is internally provided in the computer, such as a ROM or a RAM, a portable storage medium such as a CD-ROM, a flexible disk, a DVD disk, a magneto-optical disk or an IC card, a database which holds a computer program, another computer and its database, or a transmission medium on a communication line. The functions that may be installed or downloaded in advance in this manner may also be achieved in cooperation with the operating system (OS) or the like within the apparatus.

Meanwhile, a portion or the entirety of the program may be in the form of an execution module which is dynamically generated.

It is needless to say that at least some of the various processes achieved by executing the program by a CPU or an MPU in the above-described embodiment may also be executed via circuitry in an application specific integrated circuit (ASIC) included in the signage MFP 1 or the server 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for presenting sales information on a display device to a user who is shopping at a first store, comprising:
executing a first operation on a processor coupled to the display device to determine an item to promote to a user;
executing a second operation on the processor to acquire first price information about a price of the item that is on sale at the first store;
executing a third operation on the processor to acquire second price information about a price of the item that is on sale at a second store;
generating a discount information for the item that is on sale at the first store based on the first price information and the second price information; and
controlling the display device to display the generated discount information.

2. The method according to claim 1, further comprising:
receiving an identifying information of the user,
wherein the item to promote to the user is determined based on the identifying information of the user.

3. The method according to claim 2, further comprising:
executing a fourth operation on the processor to acquire past purchase information about an item that was previously purchased by the user, based on the identifying information;
determining an item that is associated with the purchased item based on the acquired past purchase information, wherein
the determined item is the item for which the first operation is executed.

4. The method according to claim 1, further comprising:
transmitting the discount information to a communication device carried by the user.

5. The method according to claim 1, further comprising:
obstructing signals transmitted from or to a communication device carried by the user so that access to a network outside the first store through the communication device is restricted.

6. The method according to claim 1, wherein
the generated discount information includes a discount offer for the item at the first store, such that the discounted price of the item at the first store is lower than the price at the second store, when the price according to the first price information is higher than the price according to the second price information.

7. The method according to claim 1, further comprising:
executing a fourth operation on the processor to acquire inventory information indicating the number of the items available at the second store, wherein
the generated discount information includes a discount offer for the item at the first store, such that the discounted price of the item at the first store is lower than the price according to the first price information and higher than the price according to the second price information, when the price according to the first price information is higher than the price according to the second price information and the number of the available items is lower than a predetermined value.

8. A non-transitory computer readable medium comprising a program that is executable in a computer system to cause the computer system to perform a method for presenting sales information on a display device to a user who is shopping at a first store, the method comprising:
executing a first operation on a processor coupled to the display device to determine an item to promote to the user;
executing a second operation on the processor to acquire first price information about a price of the item that is on sale at the first store;
executing a third operation on the processor to acquire second price information about a price of the item that is on sale at a second store;
generating a discount information for the item that is on sale at the first store based on the first price information and the second price information; and
controlling the display device to display the generated discount information.

9. The non-transitory computer readable medium according to claim 8, wherein the method further comprises:
receiving an identifying information of the user,
wherein the item to promote to the user is determined based on the identifying information of the user.

10. The non-transitory computer readable medium according to claim 9, wherein the method further comprises:
executing a fourth operation on the processor to acquire past purchase information about an item that was previously purchased by the user, based on the identifying information;
determining an item that is associated with the purchased item based on the acquired past purchase information, wherein
the determined item is the item for which the first operation is executed.

11. The non-transitory computer readable medium according to claim 8, wherein the method further comprises:
transmitting the discount information to a communication device carried by the user.

12. The non-transitory computer readable medium according to claim 8, wherein the method further comprises:
obstructing signals transmitted from or to a communication device carried by the user so that access to a network outside the first store through the communication device is restricted.

13. The non-transitory computer readable medium according to claim 8, wherein
the generated discount information includes a discount offer for the item at the first store, such that the discounted price of the item at the first store is lower than the price at the second store, when the price according to the first price information is higher than the price according to the second price information.

14. The non-transitory computer readable medium according to claim 8, wherein the method further comprises:
executing a fourth operation on the processor to acquire inventory information indicating the number of the items available at the second store, wherein
the generated discount information includes a discount offer for the item at the first store, such that the discounted price of the item at the first store is lower than the price according to the first price information and higher than the price according to the second price information, when the price according to the first price information is higher than the price according to the second price information and the number of the available items is lower than a predetermined value.

15. A system for presenting sales information, comprising:
a storage unit configured to store price information;
a display unit located at the first store; and
a control unit configured to:
determine an item to promote to the user,
acquire first price information about a price of the item that is on sale at the first store from the storage unit,
acquire second price information about a price of the item that is on sale at a second store,
generate a discount information for the item that is on sale at the first store based on the first price information and the second price information, and
control the display unit to display the generated discount information.

16. The system according to claim 15, further comprising:
an input unit configured to receive identifying information of a user who is shopping at the first store, wherein
the control unit is configured to determine the item to promote to the user based on the identifying information of the user.

17. The system according to claim 16, wherein
the control unit is further configured to
acquire past purchase information about an item that was previously purchased by the customer at the first store, based on the identification information,
determine an item that is associated with the purchased item based on the acquired past purchase information, wherein
the determined item is the item associated with the first price information.

18. The system according to claim 15, wherein
the control unit is further configured to cause the discount information to be transmitted to a communication device carried by the user.

19. The system according to claim 15, further comprising:
an obstructing unit configured to obstruct signals transmitted from or to a communication device carried by the user so that access to a network outside the first store through the communication device is restricted.

20. The system according to claim 15, wherein
the generated discount information includes a discount offer for the item at the first store, such that the discounted price of the item at the first store is lower than the price at the second store, when the price according to the first price information is higher than the price according to the second price information.
